(19) United States
(12) Patent Application Publication
(10) Pub. No.: US 2014/0082471 A1
(43) Pub. Date: Mar. 20, 2014

(54) Displaying a Syntactic Entity

(71) Applicants: Corey Reza Katouli, Huntington Beach, CA (US); Timon Safaie, Fountain Valley, CA (US)

(72) Inventors: Corey Reza Katouli, Huntington Beach, CA (US); Timon Safaie, Fountain Valley, CA (US)

(21) Appl. No.: 13/623,461

(22) Filed: Sep. 20, 2012

(51) Int. Cl. G06F 3/01

(52) U.S. Cl. 715/224

(57) ABSTRACT

An input text string may be received in a text box that is included on a web page. In response to receiving the input text string, one or more target text strings corresponding to the input text string may be identified. One or more representations of one or more syntactic entities corresponding to the one or more target strings may be identified. The one or more representations, which may be selectable when displayed, may be caused to be displayed on a display. An indication of a selected representation, which may be one of the one or more representations, may be received. In response to receiving the indication of the selected representation, a syntactic entity may be caused to be displayed in the text box in place of the input text string. The syntactic entity may correspond to a syntactic entity represented by the selected representation.

### BACKGROUND

A user may interact with a web-based application through a client terminal (e.g., a remote computing device). The user may cause the client terminal to open a web browser or similar application configured to establish a connection between the client terminal and a host of web servers. The web servers may run software programs configured to collect commands from the user via a user interface included on the client terminal. The web servers may run additional software programs configured to interpret the commands into commands executable by the web servers. In response to interpreting the commands, the web servers may execute the commands, which may result in sending data to the client terminal for displaying information, data, graphics, images, videos, and the like.

Certain web-based applications may receive information from the user via a graphical user interface (GUI). The GUI may include text fields configured to receive typed characters and/or selectable icons, graphics, or similar visual images that correspond to certain commands or functions. The user may interact with the GUI to cause the web servers to perform a command or a function.

### SUMMARY

In a first example embodiment, an input text string may be received in a text box that is included on a web page. In response to receiving the input text string, one or more target strings corresponding to the input text string may be identified. Additionally, one or more representations of one or more syntactic entities corresponding to the one or more target strings may be identified. The one or more representations may be caused to be displayed on a display. The one or more representations may be selectable when displayed. An indication of a selected representation may be received. The selected representation may be one of the one or more representations. In response to receiving the indication of the selected representation, a syntactic entity may be caused to be displayed in the text box in place of the input text string. The syntactic entity may correspond to the selected representation.

A second example embodiment may include a non-transitory computer-readable medium, having stored thereon program instructions that, upon execution by a computing device, cause the computing device to perform operations in accordance with the first example embodiment.

A third example embodiment may include a computing system comprising at least one processor, data storage, and program instructions in the data storage that, upon execution by at least one processor, cause the computing system to operate in accordance with the first example embodiment.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE FIGURES

Presently preferred embodiments are described below in conjunction with the appended drawing figures, wherein like reference numerals refer to like elements in the various figures, and wherein:

FIG. 1 depicts a communication system, according to an example embodiment.

FIG. 2 is a block diagram of a server depicted in FIG. 1, according to an example embodiment.

FIG. 3 is a block diagram of a client terminal depicted in FIG. 1, according to an example embodiment.

FIG. 4 is a flow diagram of a method for displaying a representation of a syntactic entity, according to an example embodiment.

FIGS. 5A-5C illustrate operations of a look-up table, according to an example embodiment.

FIGS. 6A-6F illustrate examples of a graphical user interface, according to an example embodiment.

### DETAILED DESCRIPTION

The following detailed description describes various features, functions, and attributes of the disclosed systems, methods, and devices with reference to the accompanying figures. In the figures, similar symbols typically identify similar components, unless context dictates otherwise. The illustrative embodiments described herein are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

### 1. Overview

Disclosed herein are methods, systems, and computing devices for displaying a syntactic entity in a text box included in a GUI. Displaying the syntactic entity in the text box may allow the user to interact with the GUI to complete an expression or a formula. This may reduce the need for the user to understand the complex syntax of programming languages that may otherwise be necessary to generate the syntactic entity in a traditional web-based application. Additionally, displaying the syntactic entity on the GUI may reduce a likelihood of a user incorrectly completing the formula or expression, thereby improving accuracy and reducing an amount of time need to enter the formula or expression.

Thus, the GUI may facilitate entering equations and/or expressions into other computer applications and/or web-based applications. For instance, a first user of the GUI may want to discuss a mathematical concept with a second user on a social networking web site. The first user may utilize the GUI to generate a mathematical expression in a text box included on a web page of the social networking web site. The second user may access the social networking web site and also use the GUI to manipulate the mathematical expression, perhaps by changing and/or expanding on the mathematical expression.

An example method may include receiving an input text string in a text box. A GUI of a web page may include a text box that is capable of receiving text entries. A user may interact with the GUI via a client terminal to enter the input text string in the text box, perhaps by using a keyboard or graphical representation of a keyboard. In response to receiving the input text string, the method may include identifying one or more target strings that corresponds to the input text string. The method may also include identifying one or more representations of one or more syntactic entities that correspond to the one or more target strings. Additionally, the method may include causing the one or more representations to be displayed on a display, such as on a display of the client terminal. The one or more representations may be selectable when displayed.

The method may further include, receiving an indication of a selected representation, which may be one of the one or more representations. The user may interact with the GUI to select the selected representation, perhaps by using a keyboard, a computer mouse, or a similar input component (or perhaps a similar representation of an input component, such as a graphical keyboard displayed on a touch screen). In response to receiving the indication of the selected representation, the method may include causing a syntactic entity to be displayed in place of the input text string. The syntactic entity may correspond to the selected representation, and may be a textual form of a non-alphanumeric character. For instance, the syntactic entity may be a textual form of an integral sign. Displaying the syntactic entity in textual form may allow a user to copy and paste an expression or a formula into another computer application, such as a word processor or a spreadsheet. Other examples, such as extracting the expression or formula to a PDF or image format, may also be possible.

### 2. Example System and Device Architecture

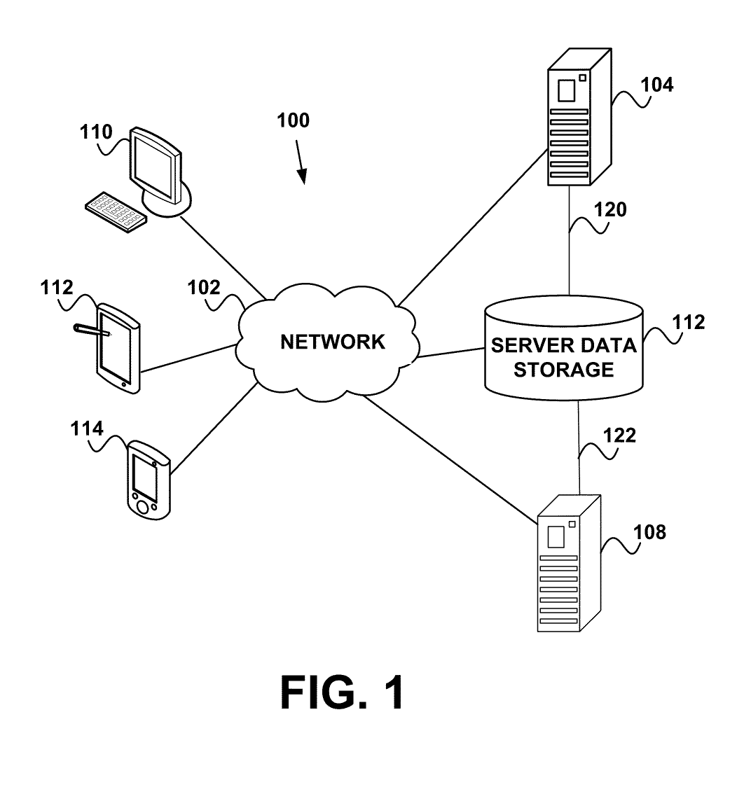

FIG. 1 depicts a communication system 100. The system 100 includes a network 102 that connects a server 104, a server data storage 106, an additional server 108, a personal computer 110, a tablet computer 112, and a smart phone 114. The personal computer 110, the tablet computer 112, and the smart phone 114 may be collectively referred to as client terminals 110-114. The client terminals 110-114 may connect to the network 102 via a wired connection and/or a wireless connection. While FIG. 1 depicts three example client terminals 110-114, more, fewer, and/or different client terminals may connect to the network 102.

In one example, the servers 104, 108 may operate independently of one another. In another example, the servers 104, 108 may operate as a server cluster. In this example, functions are distributed among the servers 104, 108 (and possibly additional servers). That is, the servers 104, 108 may pool the collective computing resources to more efficiently perform functions requested via the network 102. Additionally, while FIG. 1 depicts two servers 104, 108, more or fewer servers or combinations of servers (e.g., server clusters) may connect to the network 102.

The server 104 may communicate with one or more computing devices via the network 102, such as the client terminals 110-114 and/or the additional server 108. Communications between the server 104 and the client terminals 110-114 and/or the additional server 108 may conform to a one or more network protocols and/or application-level protocols to facilitate communication via the network 102. In one example, the network 102 may include a public Internet Protocol (IP) network, such as the Internet, and/or a private IP network. In this example, the server 104 communicates with the client terminals 110-114 and/or the additional server 108 using packet-switching technologies. Additionally, the network 102 may include hardware and possibly additional software to facilitate packet-based communications between the server 104 and the client terminals 110-114 and/or additional server 108.

In another example, the network 102 may include a public and/or private network that conforms to a different protocol. In this example, the server 104 may communicate with the client terminals 110-114 and/or the additional server 108 using circuit-switching technologies as an alternative or in addition to packet-switching technologies. The network 102 may include additional hardware and/or software components to facilitate these circuit-switching communications. In yet another example, the server 104 may communicate with the client terminals 110-114 and/or the additional server 108 using any suitable protocol now known or later discovered that is suitable for use in the network 102.

The client terminals 110-114 may communicate with the one or more of the servers 104, 108 to cause the servers 104, 108 to perform a function, such as to execute a portion of a computer program. In one example, the servers 104, 108 access the computer program, a portion of the computer program, and/or application data that is used to facilitate execution of the computer program that is stored in the server data storage 106. The servers 104, 108 may access the server data storage 106 either through wired connections 120,122 or via the network 102. Upon completion of a requested function, the servers 104, 108 may provide a result of the function to one or more of the client terminals 110-114. The servers 104, 108 may also store the result in the server data storage 106, perhaps by replacing previously stored client terminal-specific data that was previously stored in the server data storage 106.

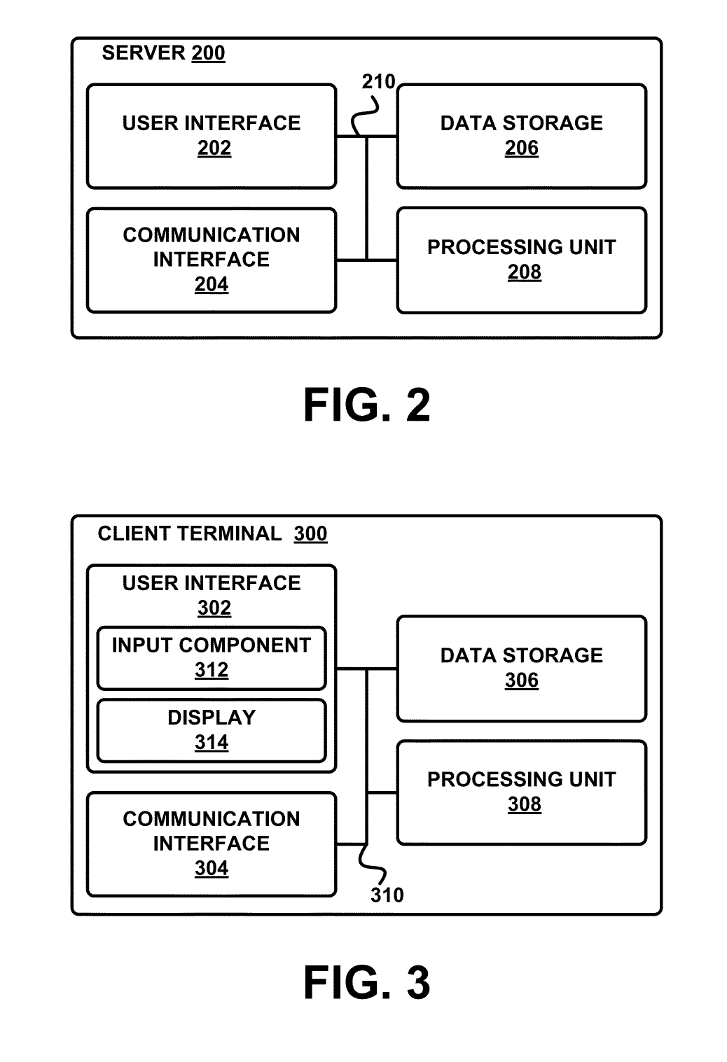

FIG. 2 is a block diagram of components of a server 200. The server 200 includes a user interface 202, a communication interface 204, a data storage 206, and a processing unit 208, all of which may be connected either directly or indirectly via circuitry 210. The server 200 is one example of the servers 104, 108 depicted in FIG. 1, and, for illustrative purposes, is described as the server 104.

The user interface 202 may include one or more devices suitable for receiving an input from a user of the server 200. The user interface 202 may include an input device, such as a keyboard, a computer mouse, a touch screen, and/or any other similar device now known or later developed suitable for receiving an input from the user. The user interface 202 may also include a display device, such as one or more cathode ray tubes (CRTs), liquid crystal displays (LCDs), light emitting diode (LED) displays, displays using digital light processing (DLP) technology, touch screens and/or any other display devices or combination of display devices now known or later developed that are suitable for displaying text, graphics, pictures, video, and/or similar visual displays of data.

The communication interface 204 may receive input signals from a client terminal, such as one of the client terminals 110-114, via the network 102. The input signals may include information indicative of an interaction by the user of the client terminal with a GUI included on a web page served by the server 200. For instance, an input signal may include information indicative of a user input, such as an input text string a text box displayed on the web page or a selection of a representation displayed on a display of the client terminal. The communication processor 204 sends input signals, as well as any other inputs received via the network 102, to the processing unit 208.

The communication interface 204 may also receive output signals from the processing unit 208 and may send the output signals to one or more of the client terminals 110-114 via the network 102. The output signals may include instructions for causing a client terminal to perform an action, such as instructions for causing the client terminal to display the web page on a display of the client terminal. The output signal may also include instructions for updating web page data that is locally stored on the client terminal, such as an update to the web page based on the user input. The communication processor 204 may also send other signals to the client terminal. Additionally, the communication processor 204 may connect the server 200 to the server data storage 106, perhaps via the wired connection 120.

The communication interface 204 may include one or more components that are configured to allow the server 200 to communicate via the network 102. In one example, the communication interface 204 may include a wired interface. The wired interface may include one or more additional components configured for exchanging data via a wired link, such as an Ethernet transceiver, a Universal Serial Bus (USB) transceiver, and/or any similar device now known or later developed suitable for exchanging data. The wired interface may also include a physical interface configured to interface with a twisted pair wire, a coaxial cable, a fiber-optic link and/or any other physical interface now known or later developed that is suitable for connecting the server 200 to a wireline device or network.

In another example, the communication interface 204 may include a wireless interface. In this example, the wireless interface may include one or more additional components configured for wirelessly exchanging data. The one or more additional components may include a BLUETOOTH® transceiver, a Wi-Fi transceiver perhaps operating in accordance with an IEEE 802.11 standard (e.g., 802.11b, 802.11g, 802.11n), a WiMAX transceiver perhaps operating in accordance with an IEEE 802.16 standard, a Long-Term Evolution (LTE) transceiver perhaps operating in accordance with a 3rd Generation Partnership Project (3GPP) standard, and/or other types of wireless transceivers now known or later developed that are configurable to wirelessly exchange data via local-area or wide-area wireless networks. In yet another example, the communication processor 204 may include one or more components configurable for conducting both wired and wireless communications.

The data storage 206 may include any type of non-transitory, tangible, computer-readable media now known or later developed configurable to store program code for execution by a component of the server 200 and/or other data associated with the server 200. The data storage 206 may store information used by the processing unit 208 to serve a web page, such as computer-readable program instructions for executing one or more computer programs and/or application-specific data.

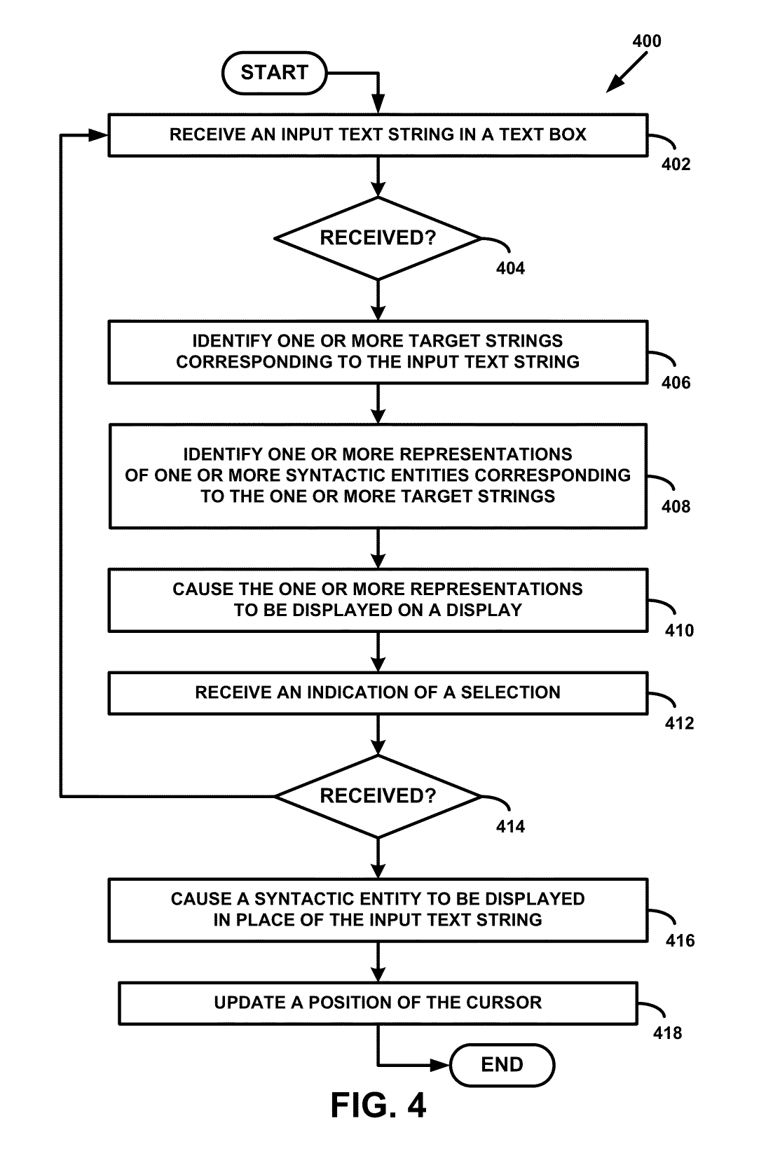

The processing unit 208 may execute computer-readable program instruction to carry out functions described herein to serve a web page. The processing unit 208 may include one or more general purpose processors, such as one or more microprocessors, and/or one or more specialized processors, such digital signal processors (DSPs), graphical processing units (GPUs) floating point processing units (FPUs), network processors and/or any other processors or combination of processors configurable for serving a web page. The processing unit 208 may process the input signal received from the communication interface 204 to identify an interaction by the user with the web site served by the server 200. The processing unit 208 may perform a function upon identifying the interaction. The processing unit 208 may subsequently access the data storage 206 and/or the server data storage 106 in order to execute computer-readable program instructions corresponding to an identified function, such as the functions described herein with respect to the method depicted in FIG. 4.

Upon completing at least a portion of the computer program, the processing unit 208 may generate the output signal. The output signal may include instructions for causing one the client terminals to perform an action, such as displaying an image, icon, picture, graphic, video, and/or similar visual representations. The processing unit 208 may send the output signal, as well as other signals, to the communication interface 204 for delivery to the client terminal via the network 102.

FIG. 3 is a block diagram of a client terminal 300. The client terminal 300 may include a user interface 302, a communication interface 304, a data storage 306, and a processing unit 308, all of which are connected either directly or indirectly by circuitry 310. The client terminal 300 is one example of one of the client terminals 110-114.

The user interface 302 may function to receive a user input from a user of the client terminal 300 and display information to the user. The user interface 302 may include an input component 312 and a display component 314. The input component 312 may capture an interaction by the user with a GUI included in a web page displayed on the display component 314. Alternatively, the user input may include information usable by the server 104 to perform a function. The input component 312 may include a keyboard, computer mouse, track ball, touch screen, or any other input device now known or later developed suitable for receiving the user input from the user. The input component 312 may send a user input signal that includes information indicative of the user input to the processing unit 308.

The display component 314 may include a display for displaying a visual image, such as an icon, picture, graphic, video, and/or other visual representation. The display component 314 may receive a display signal from the processing unit 308 that causes the display component 314 to display the visual image. In the illustrative example, in which the client terminal 300 is the tablet computer 112, the display may include a touch screen. In other examples, the display may include one or more CRTs, LCDs, LED displays, displays using DLP technology, and/or any other type of display or combination of types of displays suitable for displaying an image, icon, picture, graphic, video and/or other visual representation to the user.

The communication interface 304 may function to allow the client terminal 300 to communicate with the servers 104, 108 via the network 102. The communication interface 304 may receive output signals from the servers 104, 108 and send the output signals to the processing unit 308. The communication interface 304 may also receive input signals from the processing unit 308 and send the input signals to the servers 104, 108.

In one example, the communication interface 304 may include one or more components configurable for engaging in packet-switched communications with the servers 104, 108. In another example, the communication interface 304 may include one or more components configurable for engaging in circuit-switched communications. In yet another example, the communication interface 304 may include one or more components configurable for engaging in both circuit-switched and packet-switched communications.

The communication interface 304 may include a wireless interface. In this example, the wireless interface may include one or more additional components configured for wirelessly exchanging data. The one or more additional components may include a BLUETOOTH® transceiver, a Wi-Fi transceiver perhaps operating in accordance with an IEEE 802.11 standard (e.g., 802.11b, 802.11g, 802.11n), a WiMAX transceiver perhaps operating in accordance with an IEEE 802.16 standard, an LTE transceiver perhaps operating in accordance with a 3GPP standard, and/or other types of wireless transceivers now known or later developed that are configurable to wirelessly exchange data via local-area or wide-area wireless networks. In yet another example, the communication processor 304 may include one or more components configurable for conducting both wired and wireless communications.

In one example, the communication interface 304 may also include a wired interface. The wired interface may include one or more additional components configured for exchanging data via a wired link, such as an Ethernet transceiver, a Universal Serial Bus (USB) transceiver, and/or any similar device now known or later developed suitable for exchanging data. The wired interface may also include a physical interface configured to interface with a twisted pair wire, a coaxial cable, a fiber-optic link and/or any other physical interface now known or later developed that is suitable for connecting the client terminal 300 to a wireline device or network. In yet another example, the communication interface 304 may include one or more components configurable for conducting both wired and wireless communications.

The data storage 306 may include any type of non-transitory, tangible, computer-readable media now known or later developed configurable to store program code for execution by a component of the client terminal 300 and/or other data associated with the client terminal 300. The data storage 306 may store information used by the processing unit 308 to interact with a web page, such as computer-readable program instructions for executing one or more computer programs and/or application-specific data.

The processing unit 308 may execute computer-readable program instructions stored in the data storage 306. The processing unit 308 may include one or more general purpose processors (e.g., microprocessors) and/or one or more special purposes processors (e.g., DSPs, GPUs, FPUs, network processors). The processing unit may receive the user input signal from the user interface 302 and access the data storage 306 to process the user input signal. Depending on the application, the processing unit 308 may process the user input signal and generate an input signal that includes information indicative of the user input. For instance, the processing unit 308 may determine that the user input includes an interaction with a web page served by the server 104. In this case, the processing unit 308 may send the input signal to the communication interface 304 for delivery to the server 104.

The processing unit 308 may also receive the output signals from the communication interface 304. The processing unit 308 may access the data storage 306 in order to process the output signal. The processing unit 308 may determine that the output signal includes instructions for displaying a visual image on the display component 314. The processing unit 308 may subsequently generate and send the display signal to the display component 314 based on the instructions included in the output signal.

### 3. Example Method for Serving a Web Page

FIG. 4 is a flow diagram of a method 400. A server, such as one (or possibly both) of the servers 104, 108 depicted in FIG. 1, may perform the steps of the method 400 to display a syntactic entity on a web page. Alternatively, a number of server devices, such as server clusters, may perform one or more of the steps of method 400 to serve the web page. While the server 104 is described for purposes of illustrating the method 400, other computing devices or combinations of computing devices may be used in other embodiments.

At block 402, the method 400 includes receiving an input text string in a text box. The server 104 may serve a web page that includes a graphical user interface (GUI). When a client terminal, such as one of the client terminals 110-114, accesses the web page via the network 102, the server 104 may cause the client terminal to display the GUI on a portion of the web page displayed on a display of the client terminal. The server 104 may also cause the client terminal to display other visual images on the web page, perhaps in the form of text or pictures, in addition to the GUI.

In one example, the GUI may facilitate entry of a mathematical equation or expression that includes a mathematical syntactic entity which may not correspond to a key or combination of keys on a standard keyboard. The mathematical syntactic entity, as the term is used herein, may include a non-alphanumerical character representative of: a mathematical character, such as a representation for infinity; a mathematical operator, such as an integral; or a mathematical expression, such as a limit or intersection. The GUI may generate a textual representation (e.g., an American Standard Code for Information Interchange (ASCII) character) of the mathematical expression that the user may copy and paste into another application, such as a word processor, a spreadsheet, or a similar application. In another example, the GUI may facilitate the entry of different type of equation or expression that includes a different syntactic entity, such as a symbol or similar entity used in chemistry, computer science, physics, math and/or any other similar field in which symbols or similar non-alphanumeric characters are used.

The GUI includes the text box. The user of the client terminal may enter the input text string into the text box using a keyboard connected to or otherwise included in a user interface component of the client terminal. The input text string may include at least one typed alphanumeric character. In one example, the input text string may exclude non-alphanumeric characters.

The client terminal may identify the input text string as a user input and send a first input signal to the server 104 that includes information indicative of the input text string. In one example, the input text string may include one or more ASCII characters corresponding to the typed characters of the input text string. Upon receiving the input text string, the server 104 may send an output signal to the client terminal that includes instructions for causing the client terminal to display the input text string in the text box.

At block 404, the method 400 includes determining whether the input text string was received. If the server 104 determines that the input text string was not received, the method 400 may include repeating the steps of block 402 until the server 104 determines that the input text string was received.

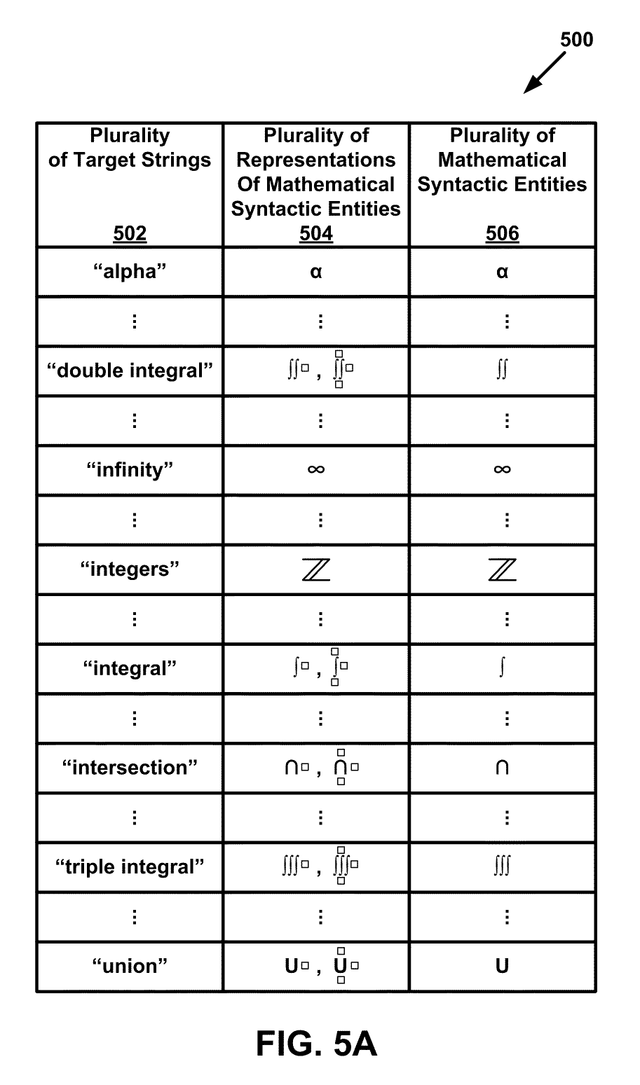

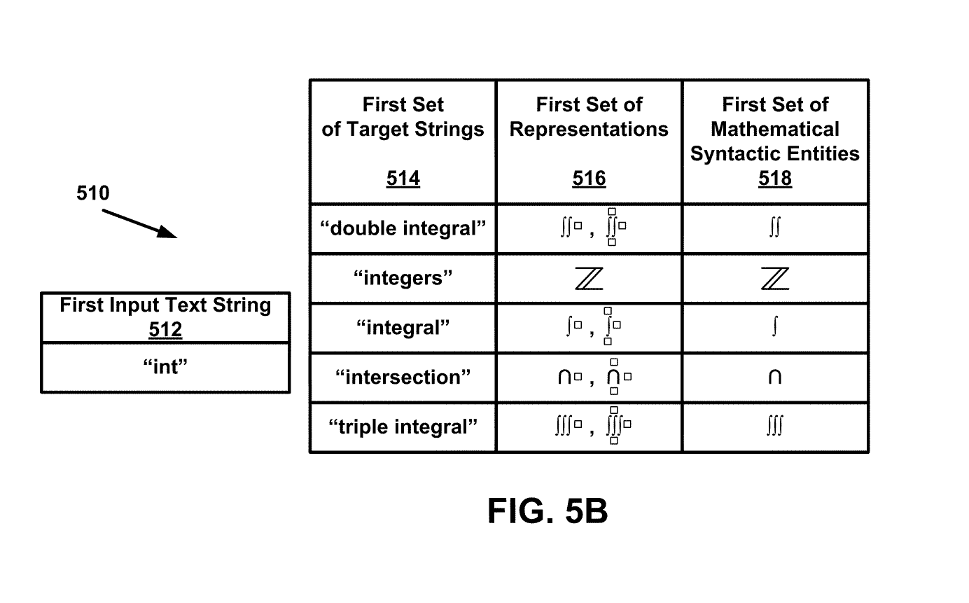

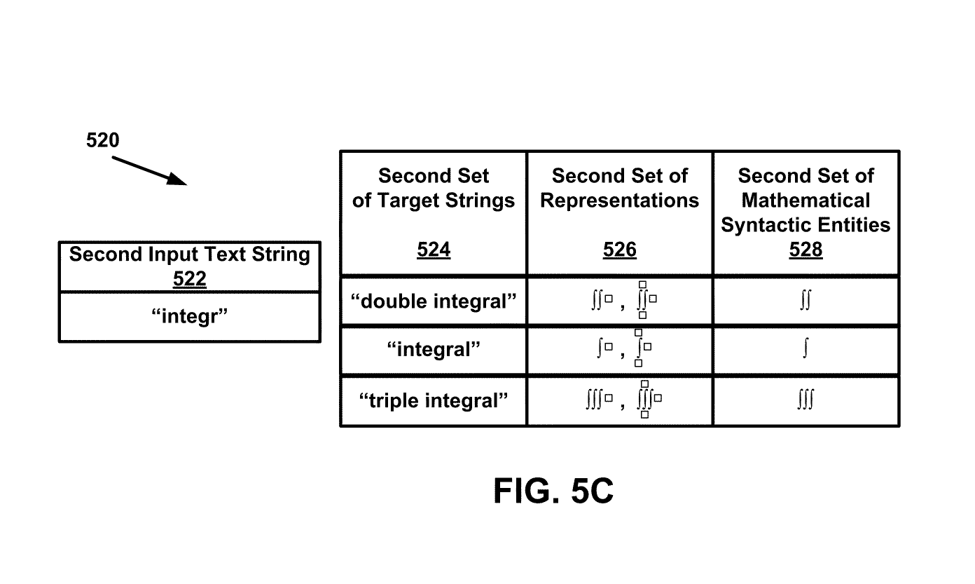

In response to receiving the input text string, the method 400 may include identifying one or more target strings corresponding to the input text string, at block 406. The server 104 may process the input signal to identify a sequence of characters included in the input text string. The server 104 may then compare, for example, the input text string to a plurality of target strings included in a look-up table. The server 104 may identify one or more target strings from the plurality of target strings that correspond to the input text string. That is, the server 104 may identify one or more targets strings that include at least the sequence of characters included in the input text string. Example operations that include using the look-up table to identify the one or more target strings are described with respect to FIGS. 5A-5C.

At block 408, the method 400 includes identifying one or more representations of one or more syntactic entities corresponding to the one or more target strings. Each of the target strings in the plurality of target strings may correspond to one or more representations of one or more syntactic entities capable of being displayed on the display of the client terminal. Example operations that include identifying one or more representations that correspond to the one or more target strings are also described further with respect to FIGS. 5A-5C.

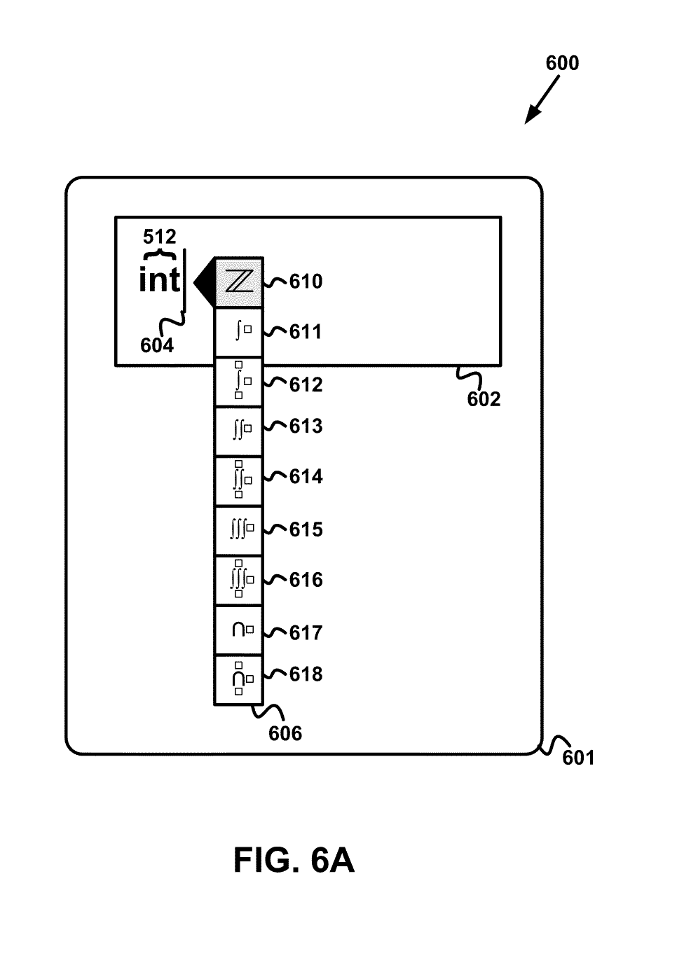

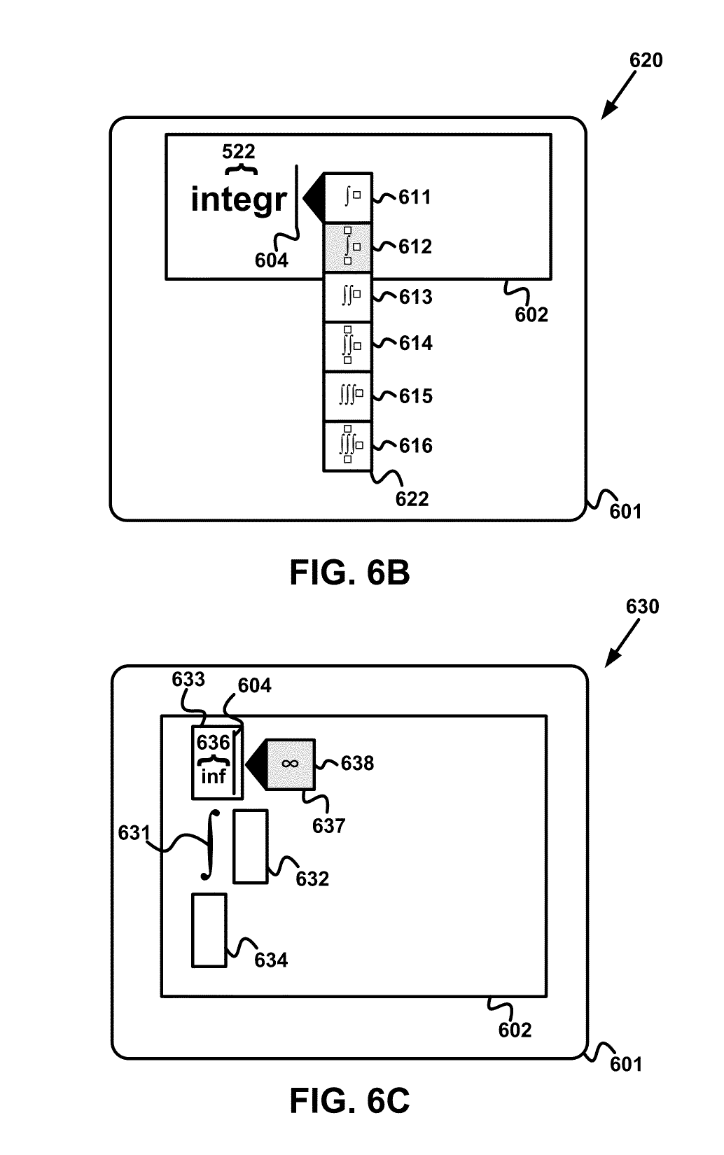

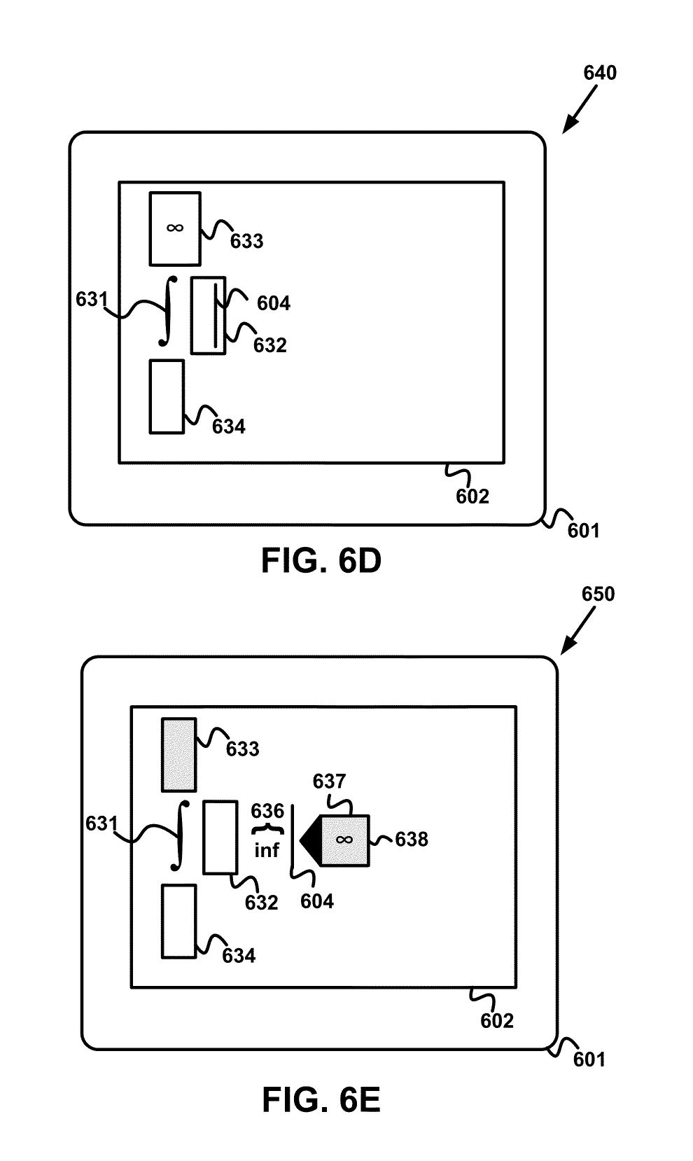

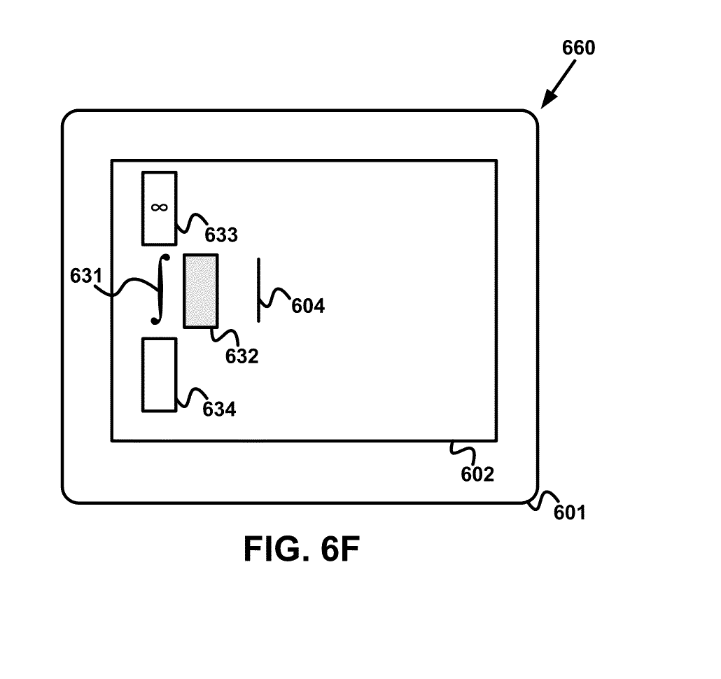

At block 410, the method 400 includes causing the one or more representations of the one or more syntactic entities corresponding to the one or more target strings to be displayed on a display. The server 104 may send an output signal to the client terminal that includes instructions for causing the client device to display the one or more representations of the one or more syntactic entities on the client terminal's display, perhaps on or in the text box. Example displays of the one or more representations are described with respect to FIG. 6A-6B.

At block 412, the method 400 includes receiving an indication of a selected representation. When displayed on the display of the client terminal, each of the one or more representations may be selectable. That is, the one or more representations may be icons, images, graphics, or similar non-textual characters. The user may select a selected representation by interacting with the GUI. The client terminal may send an input signal to the server 104 that includes information indicative of the selected representation.

The one or more representations may be displayed in a list or group proximate to the input text string and/or a cursor. In one example, the user may use the keyboard that is connected or otherwise a component of the client terminal to select the selected representation. The user may use the arrow keys, such as an up-arrow key and a down-arrow key, to highlight one of the one or more displayed representations. As used herein, the term “highlight” refers to providing an indication of a selection or potential selection, such as highlighting, shading, changing a characteristic of font, placing a box around, or otherwise providing a similar indication of the selection and/or potential selection.

Upon receiving an indication of the user pressing either of the up-arrow key or the down-arrow key, the client terminal may send an output signal indicative of the key stroke. The server 104 may receive the input signal and send an output signal to the client terminal that includes instructions for causing the client terminal to display one of the representations as a highlighted representation. When the desired representation is highlighted, the user may depress a key, such as the “Enter” key or spacebar, to select the selected representation. In another example, the user may select the selected representation from the displayed representations using a computer mouse, trackball, touch screen, or similar device.

At block 414, the method 400 includes determining whether an indication of the selected representation was received. If the indication of the selected representation was not received, the method 400 may include returning to block 402, at which point the server 104 may determine whether the user has altered the input text string. Alternatively, the server 104 may monitor for an indication of the selected representation while performing or re-performing other steps of the method 400.

In response to receiving the indication of the selected representation, the method 400 includes causing a syntactic entity to be displayed in place of the input text string in the text box, at block 416. The server 104 may receive and process the input signal that includes information indicative of the selected representation. The server 104 may identify a representation from the one or more representations that corresponds to the selected representation. The server 104 may subsequently send an output signal to the client terminal that causes the client terminal to display a syntactic entity corresponding to the selected representation.

The syntactic entity may have a similar or a same appearance as the selected representation. The syntactic entity may include a non-alphanumeric character. That is, the syntactic entity may be an ASCII character that corresponds to the selected representation. Thus, a user may copy and paste the syntactic entity into another computing program, such as a word processor, spreadsheet, and/or the like.

At block 416, the method 400 includes updating a position of a cursor included in the text box. Some of the one or more representations may include one or more fillable fields. Depending on the selected representation, the server 104 may send an output signal to the client terminal that includes instructions for causing the client terminal to display one or more text fields in the text box. The instructions may also include instructions for updating a position of the cursor position to one of the one or more text fields. The user may be able to toggle between the one or more text fields using, for example, the computer mouse and/or the tab key or the arrow keys of the keyboard.

Upon receiving an indication that the user has toggled between two text fields, the server 104 may send an output signal to the client terminal that includes information for updating the position of the cursor to a selected text field. Examples of how the server 104 may cause the client terminal to update the cursor position are described with respect to FIGS. 6C-6E.

### 4. Example Operations

The following examples describe possible operations of a server, such as one of the servers 104, 108 depicted in FIG. 1, in implementing one or more steps of the method 400. For illustrative purposes, the syntactic entities described in the following examples are mathematical syntactic entities. In other examples, the syntactic entities may include additional and/or other types or forms of syntactic entities, such as syntactic entities used in chemistry, physics, computer science, music and/or any other similar field in which symbols or similar non-alphanumeric characters are used. Thus, the operations described in the following examples should not be understood as being limited to mathematical syntactic entities.

a) Example Operations Using a Look-Up Table

FIG. 5A illustrates an example look-up table 500. The look-up table 500 is one example of a look-up table that a server may access when performing the steps of blocks 406-408 of the method 400. While the server 104 is described for purposes of illustrating operations involving the look-up table 500, other devices may also be used. In addition, although the example look-up table 500 is presented as a single table in FIG. 5A, separate tables may also be used.

The look-up table 500 may include a plurality of target strings 502, a plurality of representations of mathematical syntactic entities 504, and a plurality of mathematical syntactic entities. The look-up table 502 may be stored in the data storage 206 of the server 104 and/or in the server data storage 106. To identify the one or more target strings corresponding to the input text string, the server 104 may acquire all or a portion of the look-up table 500 by accessing the data storage 206 and/or the server data storage 106.

The look-up table 500 illustrates example targets strings and corresponding representations of mathematical syntactic entities and mathematical syntactic entities. In another example, the look-up table 500 may include more or fewer entries in each column than illustrated in FIG. 5A. Furthermore, multiple look-up tables may be used. For instance, a first look-up table may include the plurality of target strings 502 and the plurality of representations of mathematical syntactic entities 504. A second look-up table may include the plurality of representations of mathematical syntactic entities 504 and the plurality of mathematical syntactic entities 506. Other examples may also be possible.

In the example illustrated in FIG. 5A, each target string included in the plurality of target strings 502 may correspond to one or more representations of a mathematical syntactic entity included in the plurality of representations 504. For instance, in the look-up table 500, the target string “integral” may correspond to two representations of an integral: a first representation that may include fields for an upper bound and a lower bound, and a second representation that may not include these fields. In another example, each target string in the plurality of target strings 502 may correspond to a single representation included in the plurality of representations of mathematical syntactic entities 504. For instance, the target string “integral bounded” may correspond to a representation of an integral with upper and lower bound fields, whereas the target string “integral unbounded” may correspond to a representation of an integral without the upper and lower bound fields.

Each representation included in the plurality of representations 504 may correspond to a mathematical syntactic entity included in the plurality of mathematical syntactic entities 506. As previously discussed, each mathematical syntactic entity may correspond to an ASCII character or combination of ASCII characters that can be copied as text. A given representation may be a graphical form of an associated mathematical syntactic entity, thus allowing for the representation to be manipulated in a way in which the mathematical syntactic entity cannot be manipulated (e.g., the representation can be selectable).

FIG. 5B illustrates a first implementation 510 of the look-up table 500. In the first implementation 510, a first input text string 512 may include the typed characters “int.” The server 104 may compare the first input text string 512 to the target strings included in the plurality of target strings 502 of the look-up table 500. The server 104 may then identify one or more target strings included in plurality of target strings that correspond to the first input text string 512. A first set of target strings 514 may correspond to the first input text string 512. In this example, the first set of target strings 514 may include the following target strings: “double integral,” “integers,” “integral,” “intersection,” and “triple integral.” Thus, to facilitate user interaction with the GUI, the user may not have to type the target string exactly as it appears in the look-up table 500. In another example, the user may have to type the target string exactly as it appears in the look-up table 500. For instance, if the user types the first input text string 512 (i.e., “int”) into the text box, then the first set of target strings 514 may not include the following target strings: “double integral” and “triple integral.”

Each target string included in the first set of target strings 514 may correspond to one or more representations included in a first set of representations 516. Additionally, each representation included in the first set of representations 516 may correspond to a mathematical syntactic entity included in a first set of mathematical syntactic entities 518. The server 104 may send an output signal to the client terminal that includes instructions for causing the client terminal to display the representations included in the first set of representations 516 on the client terminal's display, as described herein with respect to FIG. 6A.

Upon receiving an indication of one of the representations included in the first set of representations 516 as the selected representation, the server 104 may identify the mathematical syntactic entity included in the first set of mathematical syntactic entities 518 that corresponds to the selected representation. The server 104 may send an output signal to the client terminal that includes instructions for displaying the mathematical syntactic entity, as well as any text fields associated with selectable representation, in place of the input text string 512.

FIG. 5C illustrates a second implementation 520 of the look-up table 400. In the second implementation 520, a second input text string 522 may include the typed characters “integr.” In the illustrated example, the second set of target strings 524 may include the following target strings: “double integral,” “single integral,” and “triple integral.”

In one example, the server 104 may identify a second set of target strings 524 by comparing the second input text string 522 to the plurality of target strings 502 included in the look-up table 500. In another example, the server 104 may compare the second input text string 522 to the first set of target strings 514 in order to identify the second set of target strings 524.

Each target string included in the second set of target strings 524 may correspond to one or more representations included in a second set of representations 526. Additionally, each representation included in the second set of representations 526 may correspond to a mathematical syntactic entity included in a second set of mathematical syntactic entities 528. The server 104 may send an output signal to the client terminal that includes instructions for causing the client terminal to display the representations included in the second set of representations 526 on the client terminal's display, as described with respect to FIG. 6B. In one example, the instructions may include instructions for removing representations from client terminal's display that are not included in the second set of representations 526. In another example, the instructions may include instructions for removing the representations included in the first set of representations 516 from the client terminal's display and subsequently displaying the representations included in the second set of representations 526.

Upon receiving an indication of one of the representations included in the second set of representations 526 as the selected representation, the server 104 may identify the mathematical syntactic entity included in the second set of mathematical syntactic entities 528 that corresponds to the selected representation. The server 104 may send an output signal to the client terminal that includes instructions for displaying the mathematical syntactic entity, as well as any text fields associated with selectable representation, in place of the second input text string 522.

b) Example Graphical User Interface Operation

FIGS. 6A-6F illustrate example displays of a web page served by a server or combination of servers implementing one or more of the steps of the method 400. Each of the FIGS. 6A-6E include a client terminal display 601. The client terminal display 601 may display a web page that includes a GUI. The GUI may include a text box 602 and a cursor 604. While the server 104 is described for purposes of illustrating the examples of FIGS. 6A-6E, other computing devices or combinations of computing devices may also be used.

FIG. 6A depicts a first example 600 of a GUI. In the first example 600, a user of the client terminal has entered the typed characters “int” into the text box 602. Thus, upon the user entering the typed character “t,” the text box 602 may include the first input text string 512 described with respect to FIG. 5B.

The GUI may also include a first representation field 606. The first representation field 606 may include representations 610-618 of one or more mathematical syntactic entities. In FIG. 6A, the first representation field 606 may include the first set of representations 516. The representations 610-618 may be selectable by the user. For instance, the user may use the arrow keys included on a keyboard (or a similar input device) to highlight one of the representations 610-618. That is, the server 104 may receive an indication of the user input and cause the client terminal to display an indication that one of the representations may be selected as the display representation. In FIG. 6A, a first representation 610 is shaded for illustrative purposes. When the selected representation is highlighted, the user may, for example, press the “Enter” key on the keyboard to select the highlighted representation. In another example, the user may select the selected representation from the first representation field 606 using another input component, such as a computer mouse, a track ball, a touch screen, or a similar device now known or later discovered.

As an alternative to selecting one of the representations 610-614 included in the representation field 606, the user may continue to insert typed characters into the text box 602. FIG. 6B depicts a second example 620 of the GUI. In the second example 620, the user of the client terminal has entered the typed characters “integr” into the text box 602. Thus, upon the user entering the typed character “r,” the text box 602 may include the second input text string 522 described with respect to FIG. 5C.

In FIG. 6B, a second representation field 622 may display the representations 611-616, which may be included in the second set of representations 526 described with respect to FIG. 5C. Thus, a number of selectable representations included in the second representation field 622 may be less than a number of representations in the representation field 606. The user may interact with the second representation field 622 to select one of the representations 611-616, such as the representation 612. In FIG. 6B, the representation 612, which corresponds to an integral with an upper bound field and a lower bound field, is highlighted. The user may select the representation 612 as the selected representation by pressing, for example, the “Enter” key on a keyboard (or similar device) once the representation 612 is highlighted.

FIG. 6C depicts a third example 630 of the GUI. Based on the user selecting the representation 612 as the selected representation, the server 104 may cause the client terminal to display a mathematical syntactic entity 631 corresponding to the selected representation 612 in place of the second input text string 522. As previously described, the mathematical syntactic entity 631 may correspond to a non-alphanumeric character having a same or similar appearance of the representation 612. This may allow the user to copy and paste the mathematical syntactic entity into another computer program, such as a word processor, a spreadsheet program, or the like.

The user may insert additional typed characters into one or more of an expression field 632, an upper bound field 633, and/or a lower bound field-634, which are collectively referred to as text fields 632-634 and may be displayed in addition to the mathematical syntactic entity 631. In one example, the server 104, upon causing the client terminal to display the mathematical syntactic entity 631 in place of the second input text string 522, may also cause the client device to update a position of the cursor 604 to one of the text fields 632-633. For instance, the user may select the upper bound field 633. Upon receiving an indication that the user selected the upper bound field 632, the server 104 may cause the client terminal to place the cursor 604 in the upper bound field 633. In another example, if the user does not enter text into one or more of the text fields 632-634, the server 104 may cause the client terminal to remove the one or more of the text fields 632-634. For example, if the user does not input text into either of the upper bound field 633 or the lower bound field 634, the server 104 may cause the client terminal to remove the upper bound field 633 and the lower bound field 634 from the display 601.

The user may insert one or more typed characters into the upper bound field 633. For instance, the user may insert the typed the characters “inf” into the upper bound field 633, which may correspond to a third input text string 636. Upon receiving an indication that the user inserted the third input text string 636 into the upper bound field 633, the server 104 may cause the client terminal to display the third input text string 636 in the upper bound field 633, as is illustrated in FIG. 6C.

The server 104 may also cause the client terminal to display a third representation field 637 proximate to the upper bound field 633. The server 104 may access the look-up table 500 (or a similar look-up table) to identify one or target strings that correspond to the third input text string 636. The server 104 may then identify one or more representations corresponding to one or more mathematical syntactic entities that correspond to the one or more target strings, and the server 104 may cause the client terminal to display the one or more representation in the third representation field 637. In the third example 630, the server 104 may identify the target string “infinity” as the only target string corresponding to the third input text string 636. The server 104 may subsequently cause the client terminal to display a representation 638 of the infinity symbol, which is also illustrated as being highlighted in the third example 630.

Upon the user pressing the “Enter” key (or a similar input indicating selection of the representation 638) the client terminal may send an input signal to the server 104 indicating that the representation 638 is the selected representation for the upper bound field 633. The server 104, in response, may cause the client terminal to display the infinity symbol in place of the third input text string 636. FIG. 6D illustrates a fourth example 640 in which the server 104 has caused the client terminal to display the infinity symbol in the upper bound field 633 in place of the third input text string 636. The server 104 may also cause the client terminal to update the position of the cursor 604 to one of the remaining text field 632, 634. In the fourth example 640, the server 104 causes the client terminal to display the cursor 604 in the expression field 632. In another example, the server 104 may cause the client terminal to display the cursor 604 in a lower bound field 634. Alternatively, the server 104 may not cause the client terminal to update the position of the cursor 604 after the mathematical syntactic entity has replaced the third input text string 636 in the upper bound field 633.

In another example, the server 104 does not cause the client terminal to place the cursor 504 into one of the text fields 632-634. FIG. 6E depicts a fifth example 650 of the GUI. The fifth example 650 of the GUI is substantially the same as the third example 630 of the GUI except that cursor 604 remains in-line with the mathematical syntactic entity 632. In this example, the user may select the upper bound field 633 using the keyboard, computer mouse, touch screen or other input component. Upon receiving an indication that the user selected the upper bound field 633, the server 104 may cause the client terminal to highlight the upper bound field 633, as is illustrated in FIG. 6E.

The user may insert one or more typed characters into the text box 602. In FIG. 6E, the user has inserted the third input text string 636 (i.e., “inf”) into the text box 602. The server 104 may identify the third input text string 636 and cause the client terminal to display the third representation field 637 proximate to the cursor 604. Upon receiving an indication that the user selected the representation 638 as the selected representation, the server 104 may cause the client terminal to display the infinity symbol in upper bound field 633.

FIG. 6E illustrates a sixth example 660 of the GUI, which may depict the GUI after the server 104 has caused the client terminal to display the typed character infinity symbol in the upper bound field 633. The user may then select one of the remaining fields 632, 634 to complete the mathematical equation and/or the mathematical expression. In one example, the server 104 may cause the client terminal to highlight one of the remaining fields 632, 634, such as the expression field 632, as is illustrated the sixth example.

### 5. Conclusion

With respect to any or all of the flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium, such as a storage device, including a disk drive, a hard drive, or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving an input text string in a text box, wherein the text box is included on a web page;
in response to receiving the input text string:
identifying one or more target text strings that correspond to the input text string;
identifying one or more representations of one or more syntactic entities that correspond to the one or more target strings; and
causing the one or more representations to be displayed on a display, wherein the one or more representations are selectable when displayed;
receiving an indication of a selected representation, wherein the selected representation is one of the one or more representations; and
in response to receiving the indication of the selected representation, causing a syntactic entity to be displayed in the text box in place of the target string, wherein the syntactic entity corresponds to the selected representation.

2. The method of claim 1, wherein, upon causing the selected representation to be displayed, the method further comprises:
causing one or more text fields to be displayed in the text box proximate to the syntactic entity, wherein the one or more text fields are capable of receiving a text entry;
placing a cursor of the text box in a selected text field, wherein the selected text field is one of the one or more text fields; and
receiving a second input text string, wherein the second text string is displayed in the selected text field.

3. The method of claim 1, wherein, upon causing the selected representation to be displayed, the method further comprises:
causing one or more text fields to be displayed in the text box proximate to the syntactic entity, wherein the one or more text fields are capable of receiving a text entry;
causing a selected text field to be highlighted, wherein the selected text field is one of the one or more text fields;
placing a cursor of the text box in-line with the syntactic entity;
receiving a second input text string in the text box, wherein the second input text string is displayed in-line with the syntactic entity; and
in response to receiving an indication that the second text string is complete, causing the second text string to be displayed in the text field.

4. The method of claim 1, wherein causing the one or more representations to be displayed includes causing the one or more representations to be displayed in a list proximate to the input text string.

5. The method of claim 4, further comprising:
causing one of the one or more representations displayed in the list to be highlighted.

6. The method of claim 1, wherein:
causing the one or more representations to be displayed includes causing the one or more representations to be displayed in graphical form; and
causing the syntactic entity to be displayed includes causing the syntactic entity to be displayed in textual form.

7. The method of claim 1, wherein:
the one or more syntactic entities include one or more mathematical syntactic entities; and
the syntactic entity is a mathematical syntactic entity.

8. The method of claim 1, wherein the input text string includes at least one character.

9. The method of claim 1, wherein the input text string excludes non-alphanumeric characters.

10. The method of claim 1, wherein the syntactic entity includes a non-alphanumeric character.

11. A non-transitory computer-readable medium storing instructions that, upon execution by a computing device, cause the computing device to perform functions comprising:
receiving an input text string in a text box, wherein the text box is included on a web page;
in response to receiving the input text string:
identifying one or more target text strings that correspond to the input text string;
identifying one or more representations of one or more syntactic entities that correspond to the one or more target strings; and
causing the one or more representations to be displayed, wherein the one or more representations are selectable when displayed;
receiving an indication of a selected representation, wherein the selected representation is one of the one or more representations; and
in response to receiving the indication of the selected representation, causing a syntactic entity to be displayed in the text box in place of the target string, wherein the syntactic entity corresponds to the selected representation.

12. The non-transitory computer-readable medium of claim 11, wherein, upon causing the selected representation to be displayed, the functions further comprise:
causing one or more text fields to be displayed in the text box proximate to the syntactic entity, wherein the one or more text fields are capable of receiving a text entry;
placing a cursor of the text box in a selected text field, wherein the selected text field is one of the one or more text fields; and
receiving a second input text string, wherein the second input text string is displayed in the selected text field.

13. The non-transitory computer-readable medium of claim 11, wherein, upon causing the selected representation to be displayed, the functions further comprise:
causing one or more text fields to be displayed in the text box proximate to the syntactic entity, wherein the one or more text fields are capable of receiving a text entry;
causing a selected text field to be highlighted, wherein the selected text field is one of the one or more text fields;
placing a cursor of the text box in-line with the syntactic entity;
receiving a second input text string in the text box, wherein the second input text string is displayed in-line with the syntactic entity; and
in response to receiving an indication that the second text string is complete, causing the second input text string to be displayed in the text field.

14. The non-transitory computer-readable medium of claim 11, wherein causing the one or more representations to be displayed includes causing the one or more representations to be displayed in a list proximate to the input text string.

15. The non-transitory computer-readable medium of claim 11, wherein
the one or more syntactic entities include one or more mathematical syntactic entities; and
the syntactic entity is a mathematical syntactic entity.

16. The non-transitory computer-readable medium of claim 11, wherein:
causing the one or more representations to be displayed includes causing the one or more representations to be displayed in graphical form; and
causing the syntactic entity to be displayed includes causing the syntactic entity to be displayed in textual form.

17. A computing system comprising:
at least one processor;
data storage; and
program instructions in the data storage that, upon execution by at least one processor, cause the computing system to:
receive an input text string in a text box, wherein the text box is included on a web page served by the computing system;
in response to receiving the input text string:
identify one or more target text strings that correspond to the input text string;
identify one or more representations of one or more syntactic entities that correspond to the one or more target strings; and
cause the one or more representations to be displayed, wherein the one or more representations are selectable when displayed;
receive an indication of a selected representation, wherein the selected representation is one of the one or more representations; and
in response to receiving the indication of the selected representation, cause a syntactic entity to be displayed in the text box in place of the target string, wherein the syntactic entity corresponds to the selected representation.

18. The computing system of claim 17, wherein, upon causing the selected representation to be displayed, the program instructions further cause the computing device to:
cause one or more text fields to be displayed in the text box proximate to the syntactic entity, wherein the one or more text fields are capable of receiving a text entry;
place a cursor of the text box in a selected text field, wherein the selected text field is one of the one or more text fields; and
receive a second input text string, wherein the second input text string is displayed in the selected text field.

19. The computing system of claim 17, wherein, upon causing the selected representation to be displayed, the program instructions further cause the computing device to:
cause one or more text fields to be displayed in the text box proximate to the syntactic entity, wherein the one or more text fields are capable of receiving a text entry;
cause a selected text field to be highlighted, wherein the selected text field is one of the one or more text fields;
place a cursor of the text box in-line with the syntactic entity;
receive a second input text string in the text box, wherein the second input text string is displayed in-line with the syntactic entity; and
in response to receiving an indication that the second text string is complete, cause the second text string to be displayed in the text field.

20. The computing system of claim 17, wherein:
the one or more syntactic entities include one or more mathematical syntactic entities; and
the syntactic entity is a mathematical syntactic entity.
